(19) United States
(12) Patent Application Publication
(10) Pub. No.: US 2014/0230462 A1
(43) Pub. Date: Aug. 21, 2014

(54) CRYOPUMP AND CRYOPUMP MOUNTING STRUCTURE

(71) Applicant: SUMITOMO HEAVY INDUSTRIES, LTD., Tokyo (JP)

(72) Inventor: Ken Oikawa, Tokyo (JP)

(73) Assignee: SUMITOMO HEAVY INDUSTRIES, LTD., Tokyo (JP)

(21) Appl. No.: 14/182,785

(22) Filed: Feb. 18, 2014

(30) Foreign Application Priority Data
Feb. 18, 2013 (JP) 2013-028724

(51) Int. Cl. B01D 8/00

(52) U.S. Cl. CPC B01D 8/00
USPC 62/55.5

(57) ABSTRACT

A cryopump for evacuating a vacuum chamber is provided with a radiation shield provided with a shield opening end surrounding a shield opening for receiving a gas and a lid member having a connection opening narrower than a shield opening for connecting the shield opening to the vacuum chamber. The lid member is provided with a first mounting flange for mounting the cryopump on a mating flange provided with the vacuum chamber. The first mounting flange surrounds the connection opening on a vacuum chamber side of the lid member.

### BACKGROUND OF THE INVENTION

1. Field of the Invention

The present invention relates to a cryopump and a cryopump mounting structure.

2. Description of the Related Art

There has been known a cryopump provided with a cryopanel connected to a second stage of a refrigerator cold head and cryogenically cooled, a box-shaped shield connected to a first stage of the refrigerator cold head and cryogenically cooled, a baffle connected to the shield, and a pump case containing the cryopanel, the shield, and the baffle therein. The baffle has a recess recessed from a shield opening into the shield inside. An opening of the pump case has a rectangular shape, and a ratio of the width to the height is 10:1 according to the forward flange. The width and height of the pump case opening correspond to the width and height of the shield opening, respectively.

### SUMMARY OF THE INVENTION

According to an aspect of the present invention, there is provided a cryopump for evacuating a vacuum chamber, the cryopump including a radiation shield having a shield opening end surrounding a shield opening for receiving a gas, and a lid member having a connection opening narrower than the shield opening for connecting the shield opening to the vacuum chamber. The lid member includes a first mounting flange configured to mount the cryopump on a mating flange provided with the vacuum chamber. The first mounting flange surrounds the connection opening on a vacuum chamber side of the lid member.

According to another aspect of the present invention, there is provided a cryopump mounting structure for mounting a cryopump on a mating flange provided with the vacuum chamber. The cryopump is configured to evacuate the vacuum chamber and includes an inlet flange surrounding an inlet. The mounting structure includes a lid member having a connection opening for connecting the inlet to the vacuum chamber. The lid member includes a first mounting flange surrounding the connection opening on a vacuum chamber side of the lid member and configured to mount the lid member to the mating flange, and a second mounting flange surrounding the connection opening on a cryopump side of the lid member and configured to mount the lid member on the inlet flange.

Noted that applicable aspects of the present invention also include ones in which the components and expressions of the present invention are mutually replaced among methods, apparatuses, systems, and the like.

### BRIEF DESCRIPTION OF THE DRAWINGS

Embodiments will now be described, byway of example only, with reference to the accompanying drawings which are meant to be exemplary, not limiting, and wherein like elements are numbered alike in several Figures, in which:

FIG. 1 is a side view schematically illustrating a main portion of a cryopump apparatus according to an embodiment of the present invention;

FIG. 2 is a partial side cross-sectional view schematically illustrating an inside of the cryopump apparatus according to the embodiment of the present invention;

FIG. 3 is a side view schematically illustrating a main portion of a cryopump apparatus according to another embodiment of the present invention; and

FIG. 4 is a side view schematically illustrating a main portion of a cryopump apparatus according to still another embodiment of the present invention.

### DETAILED DESCRIPTION OF THE INVENTION

The invention will now be described by reference to the preferred embodiments. This does not intend to limit the scope of the present invention, but to exemplify the invention.

In a standard way, when a cryopump is mounted on a vacuum apparatus, a cryopump having an inlet that is sized as a corresponding mating opening of the vacuum apparatus is selected. In a cryopump design, the inlet size is a representative factor for determining important specifications representing pumping performance of the cryopump such as the pumping speed and/or the total amount of gas to be pumped in the cryopump. However, in an application of the cryopump, the required pumping performance may be different from the pumping performance provided by the cryopump thus selected in the standard way. For example, the required total amount of gas to be pumped in the cryopump may exceed the level provided by the standard cryopump. Alternatively or additionally, the pumping speed lower than the maximum pumping speed that can be provided by the standard cryopump maybe sufficient in such an application.

An exemplary object of an aspect of the present invention is to provide a cryopump and a cryopump mounting structure suitable for applications requiring a relatively large amount of gas to be pumped in the cryopump and/or a relatively small pumping speed.

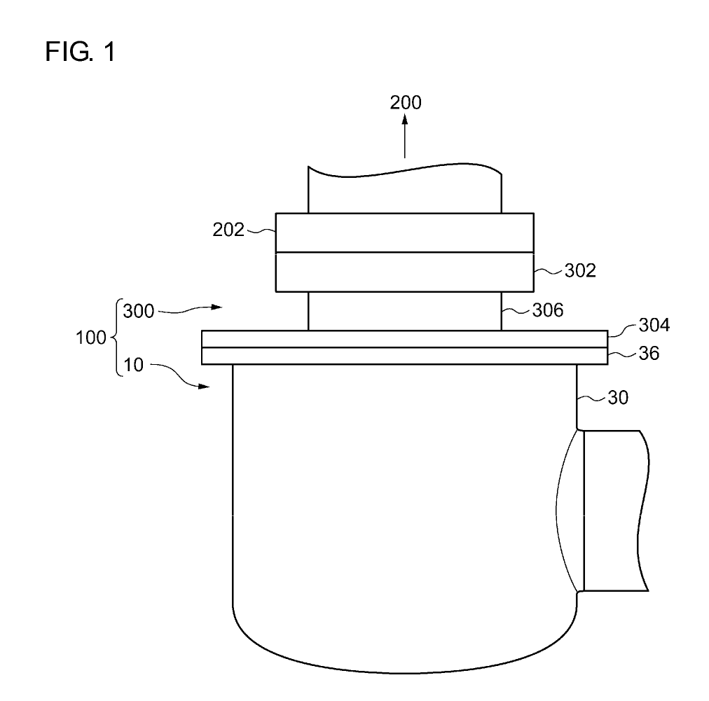

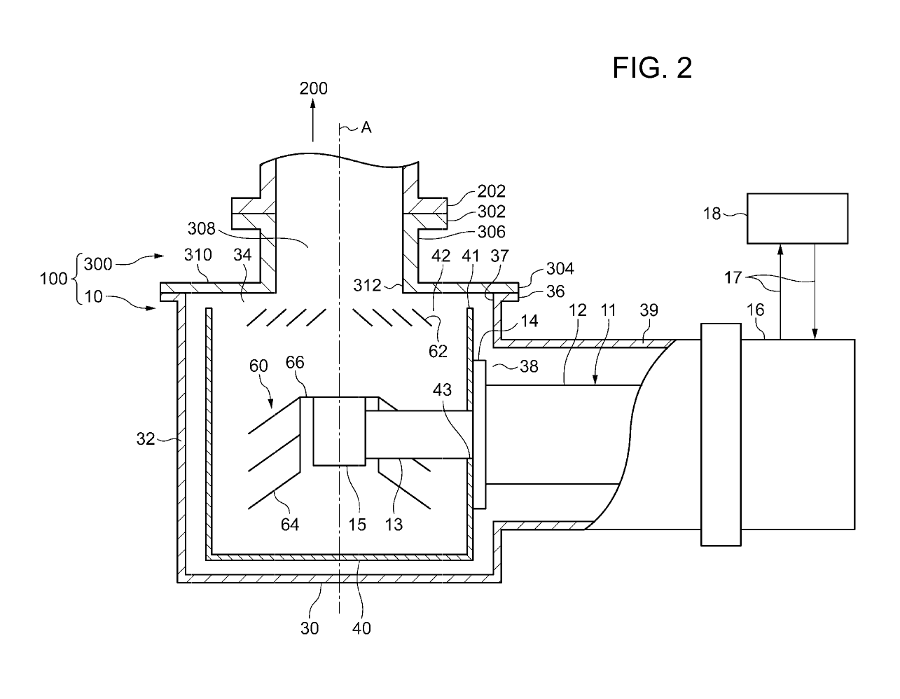

FIG. 1 is a side view schematically illustrating a main portion of a cryopump apparatus 100 according to an embodiment of the present invention. FIG. 2 is a partial side cross-sectional view schematically illustrating an inside of the cryopump apparatus 100 according to the embodiment of the present invention.

The cryopump apparatus 100 is used for, for example, evacuating a vacuum chamber 200 of a vacuum processing apparatus configured to apply a desired process to an object such as a substrate in a vacuum environment. The cryopump apparatus 100 includes a cryopump 10.

The vacuum chamber 200 includes an outlet flange 202 for mounting a vacuum pump such as the cryopump apparatus 100. The outlet flange 202 is, for example, a vacuum flange provided around an outlet of the vacuum chamber 200, or a vacuum flange provided on the vacuum pump side of a gate valve, or other vacuum valve or vacuum piping, attached to the outlet. Namely, the cryopump apparatus 100 may be directly mounted on the outlet of the vacuum chamber 200 or may be mounted on the outlet of the vacuum chamber 200 with the vacuum valve or the vacuum piping therebetween.

As described later with reference to FIG. 2, the cryopump 10 is a so-called horizontal-type cryopump including a refrigerator 11 arranged along a direction intersecting the center line A of a cryopump inlet 34. The center line A is a virtual straight line passing through the center of the cryopump inlet 34 and coincides with the center line of a shield opening 42. The cryopump inlet 34 is a main opening of the cryopump 10 formed in a cryopump housing 30 so as to receive a gas from the vacuum chamber 200. The cryopump 10 includes an inlet flange 36 surrounding the cryopump inlet 34. The inlet flange 36 is a vacuum flange having a bore diameter larger than that of the outlet flange 202. The inlet flange 36 is so formed as to protrude from an opening end of the cryopump housing 30 in an outward direction away from the center line A.

Note that terms such as “axial direction” and “radial direction” may be used herein to facilitate understanding of a positional relationship among components of the cryopump 10. The axial direction represents a direction passing through the cryopump inlet 34, and the radial direction represents a direction along the cryopump inlet 34. For convenience, relative closeness to the cryopump inlet 34 in the axial direction may be described by terms such as “upper”, and relative remoteness therefrom may be described by terms such as “lower”. In other words, relative remoteness from the bottom of the cryopump 10 may be described by terms such as “upper”, and relative closeness thereto may be described by terms such as “lower”. Relative closeness to the center of the cryopump inlet 34 in the radial direction may be described by terms such as “inner” and “inside”, and relative closeness to the circumference of the cryopump inlet 34 in the radial direction may be described by terms such as “outer” and “outside”. It should be noted here that these terms are not related to a position of the cryopump 10 as mounted on the vacuum chamber 200. For example, the cryopump 10 may be mounted on the vacuum chamber 200 with the cryopump inlet 34 facing downward in the vertical direction, contrary to the illustration.

The cryopump apparatus 100 includes a lid member 300 mounted on the inlet flange 36. The lid member 300 may be considered as a conversion port for adapting the inlet flange 36 of the cryopump 10 to the outlet flange 202 of the vacuum chamber 200. The lid member 300 is configured to narrow a gas inlet into the cryopump apparatus 100 compared to the cryopump inlet 34. The lid member 300 has a connection opening 308 (see FIG. 2) for connecting the cryopump inlet 34 to the vacuum chamber 200. The lid member 300 covers a portion of the cryopump inlet 34 other than a region opened by the connection opening 308. As described above, the conductance of the lid member 300 is determined by the connection opening 308. As described later, since the cross-sectional area of the connection opening 308 is smaller than the cryopump inlet 34, the pumping speed of the cryopump 10 is reduced by the lid member 300.

The lid member 300 includes a first mounting flange 302 surrounding the connection opening 308 on the vacuum chamber 200 side and a second mounting flange 304 surrounding the connection opening 308 on the cryopump 10 side. The first mounting flange 302 is a vacuum flange for mounting the lid member 300 on the outlet flange 202, and the second mounting flange 304 is a vacuum flange for mounting the lid member 300 on the inlet flange 36. The first mounting flange 302 and the outlet flange 202 are fixed by a fastener such as a bolt and/or a clamp, provided with a seal portion including a seal element, such as an O-ring, between the flanges. Similarly, the second mounting flange 304 and the inlet flange 36 are fixed by a fastener provided with a seal portion therebetween. The lid member 300 is fixed outside the cryopump 10 adjacent to the inlet flange 36.

The first mounting flange 302 has the same bore diameter as the outlet flange 202, and the second mounting flange 304 has the same bore diameter as the inlet flange 36. Accordingly, the bore diameter of the first mounting flange 302 is smaller than the bore diameter of the second mounting flange 304. The first mounting flange 302 and the second mounting flange 304 are formed coaxially, whereby the lid member 300 is configured such that the inlet flange 36 is mounted coaxially on the outlet flange 202.

The lid member 300 includes a connecting portion 306 connecting the first mounting flange 302 and the second mounting flange 304. The connecting portion 306 has the first mounting flange 302 at its one end and has the second mounting flange 304 at the other end. The first mounting flange 302 is so provided as to protrude from the end of the connecting portion 306 on the vacuum chamber 200 side in an outward direction away from the center line A. The second mounting flange 304 is so provided as to protrude from the end of the connecting portion 306 on the cryopump 10 side in an outward direction away from the center line A.

The first mounting flange 302 has an inner diameter equal to that of the second mounting flange 304, and the connecting portion 306 is formed into a short cylindrical shape or a ring shape. The connection opening 308 is a conduit penetrating through the connecting portion 306. Thus, a gas to be pumped enters the cryopump 10 from the vacuum chamber 200 through the connection opening 308 to the cryopump inlet 34.

As illustrated in FIG. 2, the second mounting flange 304 includes an extended portion 310 arranged radially inwardly over an inner peripheral edge 37 of the inlet flange 36. Namely, the inner peripheral edge 312 of the second mounting flange 304 is closer to the center line A than the inner peripheral edge 37 of the inlet flange 36. The cross-sectional area of the connection opening 308 is narrower than that of the cryopump inlet 34. The extended portion 310 is an annular portion on the inner periphery side of the second mounting flange 304. The second mounting flange 304 covers an outer periphery portion of the cryopump inlet 34 in this way. Also, the inner peripheral edge 312 of the second mounting flange 304 is closer to the center line A than a shield opening end 41. The cross-sectional area of the connection opening 308 is narrower than that of a shield opening 42.

The cryopump 10 is provided with the refrigerator 11 such as a Gifford-McMahon type refrigerator (generally called a GM refrigerator). The refrigerator 11 illustrated in FIG. 2 is a two-stage refrigerator and attains a lower temperature by combining cylinders in series to form two stages. The refrigerator 11 includes a first cylinder 12, a second cylinder 13, a first cooling stage 14, a second cooling stage 15, and a drive mechanism 16.

The first cylinder 12 and the second cylinder 13 are coupled in series. The first cooling stage 14 is attached to a coupling portion of the first cylinder 12 and the second cylinder 13. The second cylinder 13 connects the first cooling stage 14 and the second cooling stage 15 to each other. The second cooling stage 15 is attached to the distal end of the second cylinder 13. The first cylinder 12 and the second cylinder 13 each incorporate a regenerator therein. The drive mechanism 16 includes, for example, a rotary valve for switching a flow of working gas between the refrigerator 11 and a compressor 18 and a motor for rotating the rotary valve.

The refrigerator 11 is connected to the compressor 18 through a refrigerant pipe 17. The compressor 18 compresses a refrigerant gas such as helium, i.e., the working gas, and supplies the compressed working gas to the refrigerator 11 through the refrigerant pipe 17. In the refrigerator 11, the supplied high-pressure working gas is cooled by being passed through the regenerator. By using the drive mechanism 16, the supply flow from the high pressure side of the compressor 18 into the refrigerator 11 is switched to the exhaust flow out from the refrigerator 11 to the low pressure side of the compressor 18. When the working gas flow is switched from the supply to the exhaust, the working gas is expanded in expansion chambers inside the first cylinder 12 and the second cylinder 13 of the refrigerator 11, respectively. The expanded low-pressure gas in the expansion chambers absorbs heat to cool the cooling stages and passes through the regenerator to return to the compressor 18 through the refrigerant pipe 17.

Accordingly, the first cooling stage 14 installed on the first cylinder 12 is cooled to a first cooling temperature level, and the second cooling stage 15 installed on the second cylinder 13 is cooled to a second cooling temperature level lower than the first cooling temperature level. For example, the first cooling stage 14 is cooled to approximately 65 K to 100 K, while the second cooling stage 15 is cooled to approximately 10 K to 20 K.

The cryopump 10 further includes a cryopump housing 30. The cryopump housing 30 has a portion (hereinafter referred to as a “trunk portion”) 32 formed into a cylindrical shape having an opening at one end and a closed other end. This opening is provided as the cryopump inlet 34 for receiving a gas to be pumped from the vacuum chamber 200 of e.g., a sputtering apparatus connected to the cryopump 10. The cryopump inlet 34 is defined by an inner surface of an upper end of the trunk portion 32 of the cryopump housing 30. The inlet flange 36 extends outward in the radial direction from the upper end of the trunk portion 32 of the cryopump housing 30.

Aside from the cryopump inlet 34, the trunk portion 32 has an opening 38 through which the refrigerator 11 is inserted. One end of a refrigerator receiving portion 39, which is cylindrically shaped, is attached to the opening 38 of the trunk portion 32, and the other end is attached to a housing (for example, for the drive mechanism 16) of the refrigerator 11. The refrigerator receiving portion 39 contains the first cylinder 12 of the refrigerator 11 therein.

The cryopump housing 30 is provided for isolating the interior from the exterior of the cryopump 10. As described above, the cryopump housing 30 is configured to include the trunk portion 32 and the refrigerator receiving portion 39, and the inside of the trunk portion 32 and the refrigerator receiving portion 39 is maintained airtight at a common pressure. According to this configuration, the cryopump housing 30 functions as a vacuum vessel during a pumping operation of the cryopump 10. An outer surface of the cryopump housing 30 is exposed to an external environment of the cryopump 10 during the operation of the cryopump 10, that is, while the refrigerator operates. Thus, the temperature of the cryopump housing 30 is higher (for example, approximately a room temperature) than the cooling temperature of the refrigerator 11.

The cryopump 10 includes a radiation shield 40. The radiation shield 40 is disposed inside the cryopump housing 30. The radiation shield 40 is formed into a cylindrical shape having a shield opening 42 at one end and a closed other end, that is, a cup shape. The radiation shield 40 may be formed as a one-piece tube as illustrated in FIG. 2. Alternatively, a plurality of parts may form a tubular shape as a whole. The plurality of parts may be arranged so as to have a gap between one another.

The trunk portion 32 of the cryopump housing 30 and the radiation shield 40 are both formed as substantially cylindrical shapes and are arranged coaxially. The inner diameter of the trunk portion 32 of the cryopump housing 30 is slightly larger than the outer diameter of the radiation shield 40. Therefore, the radiation shield 40 is arranged in the cryopump housing 30 without contact, arranged at a slight gap from the inner surface of the trunk portion 32 of the cryopump housing 30. That is, the outer surface of the radiation shield 40 faces the inner surface of the cryopump housing 30. Note that the shapes of the trunk portion 32 of the cryopump housing 30 and the radiation shield 40 are not limited to cylindrical but may be tubes having a rectangular or elliptical cross section, or any other cross section. Typically, the shape of the radiation shield 40 is analogous to the shape of the inner surface of the trunk portion 32 of the cryopump housing 30.

As described above, the cryopump 10 includes the radiation shield 40 provided with a cylindrical portion having the shield opening end 41 at the cryopump inlet 34. The shield opening end 41 surrounds the shield opening 42. The inlet flange 36 includes the inner peripheral edge 37 defining the cryopump inlet 34. The inner peripheral edge 37 of the inlet flange 36 is located outside the shield opening end 41 in a direction perpendicular to the center line A of the shield opening 42.

Since the outer diameter of the radiation shield 40 is smaller than the inner diameter of the inlet flange 36, the inlet flange 36 does not interfere with the radiation shield 40 when the radiation shield 40 is inserted into the cryopump housing 30 through the cryopump inlet 34 during the manufacturing process of the cryopump 10. Thus, the radiation shield 40 can be assembled on the cryopump 10 through the cryopump inlet 34. After the radiation shield 40 is put into the cryopump housing 30 and is assembled, the lid member 300 is mounted on the cryopump 10.

The radiation shield 40 has a refrigerator mounting hole 43 in the side surface. The refrigerator mounting hole 43 is provided at a middle portion of the side surface of the radiation shield 40 with respect to a direction along the central axis of the radiation shield 40. The refrigerator mounting hole 43 of the radiation shield 40 is provided coaxial with the opening 38 of the cryopump housing 30. The second cylinder 13 and the second cooling stage 15 of the refrigerator 11 are inserted through the refrigerator mounting hole 43 along a direction perpendicular to the central axis of the radiation shield 40. The radiation shield 40 is fixed to the first cooling stage 14 around the refrigerator mounting hole 43 in a state of being thermally connected to the first cooling stage 14.

The cryopump 10 illustrated in FIG. 2 is a so-called horizontal-type cryopump. Generally, the horizontal-type cryopump is configured such that the second cooling stage 15 of the refrigerator 11 inserted into the radiation shield 40 along a direction intersecting (in general, perpendicular to) the axial direction of the cylindrical radiation shield 40. The present invention is also applicable to a vertical-type cryopump in a similar manner. The vertical-type cryopump is a cryopump with a refrigerator inserted along the axial direction of the radiation shield.

The cryopump 10 includes a low-temperature cryopanel 60. The low-temperature cryopanel 60 includes, for example, a plurality of panels 64. Each of the panels 64 has a shape of the side surface of a truncated cone, i.e., an umbrella-like shape. Each of the panels 64 is mounted on a panel mounting member 66 mounted on the second cooling stage 15. Typically, an adsorbent (not illustrated) such as activated carbon is provided on each of the panels 64. The adsorbent is, for example, adhered to the back face of the panels 64. The panels 64 are mounted and arranged at a distance from each other on the panel mounting member 66. The panels 64 are arranged in a direction towards the inside of the pump when viewed from the cryopump inlet 34.

The radiation shield 40 is provided as a heat shield protecting the second cooling stage 15 and the low-temperature cryopanel 60, thermally connected to the second cooling stage 15, from radiant heat emitted mainly from the cryopump housing 30. The second cooling stage 15 is arranged on a substantially central axis of the radiation shield 40 within the radiation shield 40. The radiation shield 40 is fixed in a state of being thermally connected to the first cooling stage 14 and cooled to a comparable temperature to that of the first cooling stage 14.

The radiation shield 40 has a baffle 62 at its entrance to protect the second cooling stage 15 and the low-temperature cryopanel 60, thermally connected to the second cooling stage 15, from radiant heat emitted from the vacuum chamber and associated components. The baffle 62 is formed to have a louver structure or a chevron structure, for example. The baffle 62 may be concentrically formed around the center axis of the radiation shield 40 or may be formed into another shape such as a lattice shape. The baffle 62 may be a flat plate having a large number of through-holes.

The baffle 62 is mounted on the opening end of the radiation shield 40 and cooled to a comparable temperature to that of the radiation shield 40. The cooled baffle 62 cools molecules of the gases flowing from the vacuum chamber 200 into the cryopump 10 to cause gases having vapor pressures that are sufficiently reduced by the cooling temperature of the baffle 62 (for example, moisture) to condense on a surface of the baffle 62 for the vacuum pumping. Gases having vapor pressures that are not sufficiently reduced by the cooling temperature of the baffle 62 pass through the baffle 62 to enter the inside of the radiation shield 40.

Of the molecules of the gases that have entered, gases having vapor pressures that are sufficiently reduced by a cooling temperature of the low-temperature cryopanel 60 are condensed on a surface of the low-temperature cryopanel 60 for the vacuum pumping. Gases having vapor pressures that are not sufficiently reduced by this cooling temperature (for example, hydrogen) are adsorbed onto the cooled adsorbent that is adhered to the surface of the low-temperature cryopanel 60 for the vacuum pumping. In this way, the cryopump 10 can attain a desired level of vacuum in the vacuum chamber 200.

According to circumstances of the industry, the bore diameter of the cryopump inlet defines a product lineup of cryopumps. Cryopump manufacturers typically manufacture and sell cryopumps of standard specifications according to bore diameters at 2-inch or 4-inch intervals, for example, at 8, 10, and 12 inches and so on. This is because the bore diameter of the cryopump inlet is to be fitted with the bore diameter of the corresponding outlet of the vacuum chamber. Accordingly, when the outlet bore diameter of the vacuum chamber is 8 inches, in turn a cryopump having a bore diameter of 8 inches is selected.

The pumping speed and the total amount of gas pumped in the cryopump are typically used to represent the performance of the cryopump. Since the pumping speed is regulated by the bore diameter of the cryopump, the larger the size of the cryopump, the higher the pumping speed. Similarly, since the total amount of gas pumped in the cryopump is regulated by the surface area of the cryopanel built in the cryopump, the larger the size of the cryopump, the larger the total amount of gas pumped in the cryopump.

In an application of the cryopump, a relatively large amount of gas to be pumped in the cryopump may be required. The required amount of gas pumped in the cryopump may exceed that of the cryopump selected corresponding to the outlet of the vacuum chamber. In such an application, a high pumping speed may not be required so much, i.e., a relatively small pumping speed may be sufficient. An example of such an application is an application where most of the gas pumped is argon, and a representative example is a sputtering apparatus.

As described above, the cryopump apparatus 100 according to this embodiment is provided with the lid member 300 closing a portion of the inlet 34 of the cryopump 10. The lid member 300 includes the connection opening 308 for connecting the cryopump inlet 34 to the vacuum chamber 200. Such a lid with an opening limits the inlet 34 and the shield opening 42, whereby the pumping speed of the cryopump apparatus 100 can be reduced.

The lid member 300 includes the first mounting flange 302, smaller than the inlet flange 36, on the vacuum chamber 200 side. Accordingly, the large sized cryopump 10 can be installed in the small outlet of the vacuum chamber 200 by using the lid member 300. For example, the cryopump 10 having a bore diameter of 12 inches can be installed at the outlet flange 202 having a bore diameter of 8 inches. As described above, a large total amount of gas pumped in the cryopump can be provided by a simple and low cost method of providing the lid member 300. Consequently, it is advantageous in terms of allowing the reduction of a frequency of regeneration of the cryopump 10, for example.

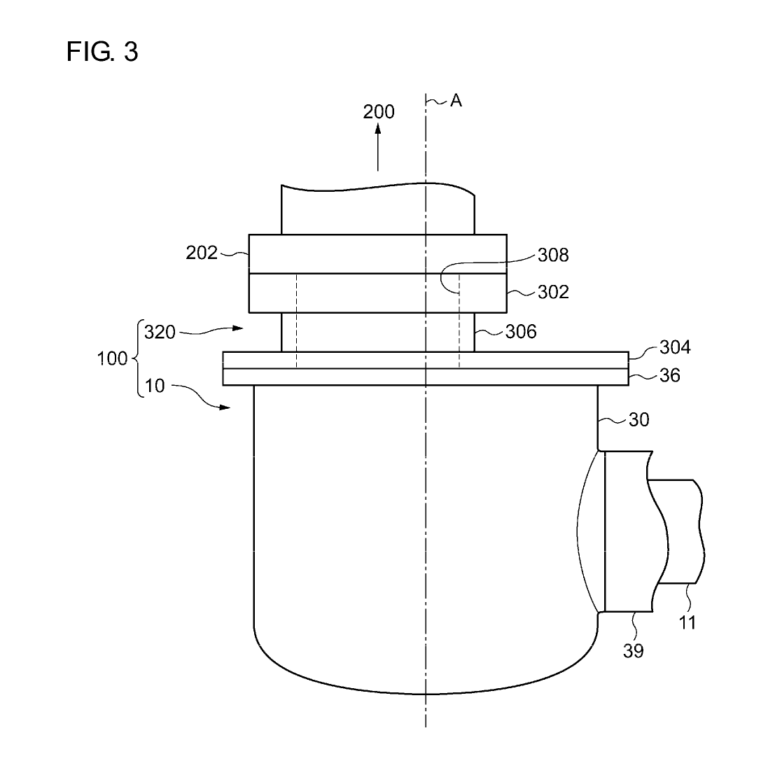

FIG. 3 is a side view schematically illustrating a main portion of a cryopump apparatus 100 according to another embodiment of the present invention. The cryopump apparatus 100 includes a horizontal-type cryopump 10 similar to that in the above-described embodiment. The cryopump apparatus 100 is different from that in the above embodiment in that a lid member 320 includes a first mounting flange 302 at a position away from the center of a second mounting flange 304.

In the lid member 320 illustrated in FIG. 3, the connection opening 308 (illustrated by dashed lines in FIG. 3) is eccentric from the center line A so as to be away from a high temperature side of the refrigerator 11. Thus, the first mounting flange 302 and the connecting portion 306 are arranged to be shifted from the center line A to the side opposite to the refrigerator receiving portion 39 of the cryopump housing 30. The distance from the refrigerator mounting hole 43 to the connection opening 308 is larger than the distance from the refrigerator mounting hole 43 to the center line A.

In the horizontal-type cryopump 10, a gas is condensed on a surface of the second cylinder 13 (see FIG. 2), more specifically an upper side surface facing the cryopump inlet 34, and an ice layer is deposited. The ice layer on the surface of the second cylinder 13 may cause instability of a degree of vacuum. The instability of the degree of vacuum occurs due to a temperature gradient on the surface of the second cylinder 13.

The temperature gradient is generated on the surface of the second cylinder 13 from the second cooling temperature of the second cooling stage 15 to the first cooling temperature of the first cooling stage 14. The temperature range from the second cooling temperature to the first cooling temperature includes a boiling point of gas (for example, argon) condensed on the low-temperature cryopanel 60. Thus, the surface of the second cylinder 13 has a position corresponding to the temperature of the boiling point of the gas. When the cryopump 10 is used, as the deposition of the ice layer on the lower-temperature cryopump 60 progresses, a thermal load on the lower-temperature cryopump 60 increases. Thereby the temperature of the lower-temperature cryopump 60 may be varied, so that the position of the gas boiling point temperature moves on the surface of the second cylinder 13 (right and left in FIG. 2).

At that time, a portion of the ice layer deposited on the second cylinder 13 is rapidly vaporized by a temperature change on the surface of the second cylinder 13 to deteriorate the degree of vacuum. For example, the temperature of the second cooling stage 15 increases, and when the gas boiling point temperature position moves in a direction approaching the second cooling stage 15, the gas condensed at the original gas boiling point temperature position cannot keep the condensed state and is thus rapidly vaporized.

The cryopump 10 may be provided with a refrigerator cover enclosing the second cylinder 13. The refrigerator cover is formed into a cylindrical shape having a diameter slightly larger than that of the second cylinder 13. One end of the cylindrical refrigerator cover is attached to the second cooling stage 15, and the other end extends toward the radiation shield 40. A gap is provided between the refrigerator cover and the radiation shield 40, and the refrigerator cover and the radiation shield 40 are not in contact with each other. The refrigerator cover is thermally connected to the second cooling stage 15 and is cooled to the same temperature as the second cooling stage 15. Since the second cylinder 13 is covered by the refrigerator cover, the ice layer is formed on not the second cylinder 13 but the refrigerator cover. Thus, the instability of the degree of vacuum can be prevented.

When the ice layer is accumulated on the refrigerator cover, the ice layer may be in contact with the radiation shield 40 at an end of the refrigerator cover close to the radiation shield 40. The ice layer in contact with the radiation shield 40 is heated by the radiation shield 40 and is rapidly vaporized. In this case, it is difficult for the cryopump 10 to further enhance the degree of vacuum.

According to the cryopump apparatus 100 illustrated in FIG. 3, the connection opening 308 of the lid member 320 is away from the high temperature side of the second cylinder 13. Corresponding to such an arrangement of the connection opening 308, a gas can be guided to a place away from the second cylinder 13. In this way, since the deposition of the ice layer on the second cylinder 13 and the refrigerator cover can be reduced, the instability or deterioration of the degree of vacuum can be suppressed.

The lid member 320 may be provided with the first mounting flange 302 and the connection opening 308 that are located at any place deviated from the center of the second mounting flange 304. According to this configuration, a gas can be guided to a desired place corresponding to an arrangement of the cryopanel in the cryopump 10.

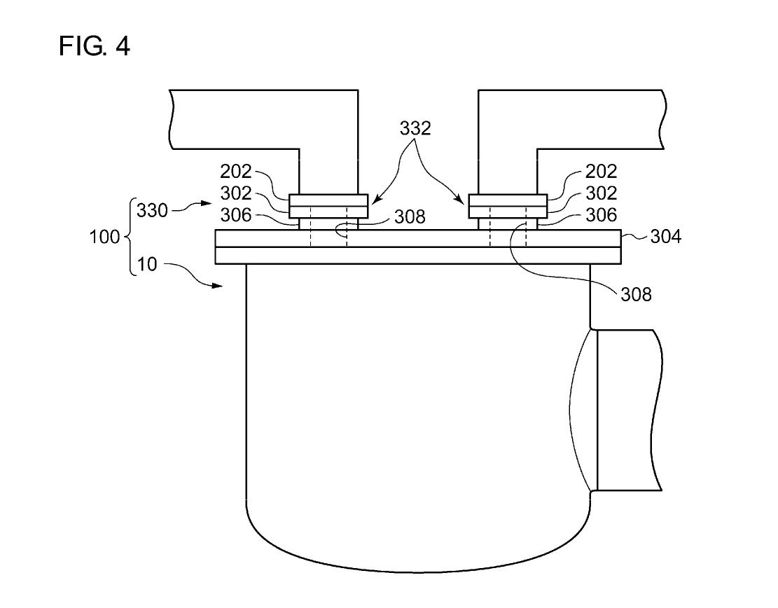

FIG. 4 is a side view schematically illustrating a main portion of a cryopump apparatus 100 according to still another embodiment of the present invention. The cryopump apparatus 100 includes a horizontal-type cryopump 10 similar to that in the above embodiment. The cryopump apparatus 100 is different from the above embodiment in that a lid member 330 is provided with a plurality of connection openings 308 (illustrated by dashed lines in FIG. 4).

The lid member 330 includes a plurality of connection ports 332 for connecting the cryopump inlet 34 to the outside of the cryopump 10. FIG. 4 illustrates the lid member 330 provided with the two connection ports 332. These connection ports 332 are provided at the second mounting flange 304. Each of the connection ports 332 is provided with a first mounting flange 302 and a connecting portion 306 and has the connection opening 308. Each of the connection ports 332 is mounted on an individual outlet flange 202. According to this configuration, the cryopump 10 can be connected to a plurality of vacuum chambers.

The above has described the present invention based on embodiments. Those skilled in the art will appreciate that the present invention is not limited to the embodiments described above, that various design changes and modifications are possible, and that such modifications are also within the scope of the present invention.

In the above embodiments, the connection opening 308 of the lid member 300 is opened. However, the lid member 300 may be provided with a narrower portion in the connection opening 308 configured to restrict an inflow of gas from the vacuum chamber 200 to the cryopump inlet 34. The narrower portion may include any element configured to reduce the cross-sectional area of the connection opening 308. For example, the lid member 300 may be provided with a baffle disposed in a conduit forming the connection opening 308. The baffle may have a movable louver configured to adjust the opening area of the connection opening 308.

In the above embodiments, the first mounting flange 302 and the second mounting flange 304 of the lid member 300 have different bore diameters corresponding to the outlet flange 202 and the inlet flange 36, respectively. When the outlet flange 202 (and/or the inlet flange 36) has a shape other than a circular shape, the lid member may include a mounting flange having a shape corresponding to the outlet flange 202 (and/or the inlet flange 36). For example, when the outlet flange 202 and/or the inlet flange 36 has a rectangular shape, the mounting flange of the lid member may have a corresponding rectangular shape. By virtue of the use of such a lid member, the cryopump 10 can be mounted on the outlet flange 202 having a shape and/or size different from the shape and/or size of the inlet flange 36 of the cryopump 10. An opening, a tube, or a pipe (for example, the connection opening 308) associated with the lid member may have any cross-sectional shape other than a circular shape, for instance, a rectangular shape.

In the above embodiments, the inlet flange 36 has a size larger than that of the first mounting flange 302. However, the inlet flange 36 may be of the same size as the first mounting flange 302. Also in this case, the lid member 300 can adjust the pumping speed according to the size of the connection opening 308. Alternatively, the inlet flange 36 may have a size smaller than that of the first mounting flange 302. In this case, a small sized cryopump can be mounted on the vacuum chamber.

In the above embodiments, the lid member 300 is a separate member mounted removably on the cryopump 10. However, the lid member may be a member integral with the cryopump. Thus, in an embodiment, the cryopump may include a lid member formed integrally with the cryopump housing to cover the inlet of the cryopump. In this case, the cryopump may not include the inlet flange. Further, the lid member may not include the second mounting flange.

It should be understood that the invention is not limited to the above-described embodiment, but may be modified into various forms on the basis of the spirit of the invention. Additionally, the modifications are included in the scope of the invention.

Priority is claimed to Japanese Patent Application No. 2013-28724, filed on Feb. 18, 2013, the entire content of which is incorporated herein by reference.

What is claimed is:

1. A cryopump for evacuating a vacuum chamber, the cryopump comprising:
a radiation shield comprising a shield opening end surrounding a shield opening for receiving a gas; and
a lid member having a connection opening narrower than the shield opening for connecting the shield opening to the vacuum chamber, wherein the lid member comprises a first mounting flange configured to mount the cryopump on a mating flange provided with the vacuum chamber, the first mounting flange surrounding the connection opening on a vacuum chamber side of the lid member.

2. The cryopump according to claim 1, further comprising:
a cryopump housing containing the radiation shield therein, wherein
the cryopump housing comprises an inlet flange surrounding an inlet and having a size larger than that of the first mounting flange, and
the lid member comprises a second mounting flange configured to mount the lid member on the inlet flange, the second mounting flange surrounding the connection opening on a cryopump side of the lid member.

3. The cryopump according to claim 2, wherein
the inlet flange comprises an inner peripheral edge defining the inlet, and the inner peripheral edge is located outside the shield opening end in a direction perpendicular to a center line of the shield opening.

4. The cryopump according to claim 1, further comprising:
a low-temperature cryopanel disposed in the radiation shield; and
a refrigerator comprising a first cooling stage for cooling the radiation shield, a second cooling stage for cooling the low-temperature cryopanel, and a second cylinder connecting the first cooling stage and the second cooling stage, the second cylinder arranged within the radiation shield along a direction intersecting a center line of the shield opening, wherein
the first mounting flange is provided at a position deviated from the center line to be away from a high temperature side of the second cylinder.

5. The cryopump according to claim 1, wherein
the lid member comprises a narrower portion in the connection opening, the narrower portion restricting an inflow of gas from the vacuum chamber to the shield opening.

6. The cryopump according to claim 1, wherein
the lid member comprises a plurality of connection ports for connecting the shield opening to the outside of the cryopump.

7. A cryopump mounting structure for mounting a cryopump on a mating flange provided with a vacuum chamber, the cryopump configured to evacuate the vacuum chamber and comprising an inlet flange surrounding an inlet, the mounting structure comprising:
a lid member having a connection opening for connecting the inlet to the vacuum chamber, wherein the lid member comprises a first mounting flange surrounding the connection opening on a vacuum chamber side of the lid member and configured to mount the lid member on the mating flange, and a second mounting flange surrounding the connection opening on a cryopump side of the lid member and configured to mount the lid member on the inlet flange.
